(19) United States
(12) Patent Application Publication
(10) Pub. No.: US 2003/0222120 A1
(43) Pub. Date: Dec. 4, 2003

(54) Devices for and methods of casting and bonding a molten material onto one or more surfaces of a moving substrate

(76) Inventors: Joseph G. Kaiser, Barrington, RI (US); Arthur Luciano, Riverside, RI (US); Joseph P. Mennucci, Manville, RI (US); Gary B. Davies, West Greenwich, RI (US); Walter C. McConaghy, Mansfield, MA (US); John D. Rose, Coventry, RI (US)

Correspondence Address: EDWARDS & ANGELL, LLP, P.O. BOX 9169, BOSTON, MA, 02209, US

(21) Appl. No.: 10/157,381

(22) Filed: May 29, 2002

(51) Int. Cl. B23K 1/00

(52) U.S. Cl. 228/101

(57) ABSTRACT

Methods of and devices for continuously casting molten material onto one or more surfaces of a moving substrate to provide one or more profiles on one or more surfaces are disclosed in the present invention. In a preferred embodiment, the casting method includes providing a substrate, heated reservoir of a molten material, and a casting die; moving the substrate past the casting die into which the molten material is introduced; containing the molten material against the one or more surfaces of the moving substrate; heating the casting die to prevent the molten material from solidifying prematurely; and cooling the molten material to solidify the molten material to provide one or more profiles on the one or more surfaces of the moving substrate and to bond the solidified profile(s) to the one or more surfaces. In a preferred embodiment, the device for casting and bonding a molten material to one or more surfaces of a moving substrate includes a casting die for wetting the moving substrate with the molten material to provide one or more desired profiles on one or more surfaces of the moving substrate; a heating system to prevent molten material from solidifying in the casting die; and a cooling device for solidify the molten material in the desired profile(s) and for bonding the desired profile(s) to the one or more surfaces of the moving substrate.

### FIELD OF INVENTION

The present invention relates to devices for and methods of continuous forming a profile, e.g., a metallic profile, on a moving substrate. More particularly, the present invention relates to devices for and methods of continuously casting a molten material, e.g., solder, onto at least one surface of a moving substrate, e.g., a base metal substrate, to provide a profile, and a casting die therefor.

### DESCRIPTION OF THE RELATED ART

Methods of joining materials, e.g., metals, that are of different composition and/or exhibit different material properties, e.g., melting point, include, inter alia, soldering, welding, coating, cladding, and casting. Soldering comprises a method of making a connection, or bond, between a solder and a base metal having a higher melting point than the solder. In the soldering process, the solder and base metal are heated to a temperature at which the solder chemically reacts with the base metal to form a bond.

Welding involves joining two dissimilar metals through the creation of a molten weld puddle, which is comprised of both parent metals. In welding, neither component is totally consumed and, furthermore, both parent metals remain solid and in their original geometry except at the common molten weld zone.

As its name suggests, “coating” involves applying a relatively thin layer of metal, e.g., lead, to a base metal, e.g., steel, and allowing the applied metal, i.e., the “coating”, to cool to form a new layer on the base metal. Coating can be applied through molten dipping, thermal spraying, vapor depositing or sputtering techniques. Application rate of the coating and duration of the technique determines the coating thickness.

Cladding involves joining metals and/or alloys using force or pressure. Bonding between clad layers depends on atomic attraction or diffusion between dissimilar metals brought into intimate contact.

Casting technology has developed from historical static casting techniques in which molten metal is poured into a stationary block mold. Developments over the past half-century have seen commercialization of continuous casting technology. With casting, molten metal is continuously fed into an open, e.g., four-sided or round die to produce long castings of a given cross-section. Continuous casting methods to date, however, involve only one alloy or metal.

For more than thirty years, the metals industry has produced electronic components and other devices comprising a strip of metal bonded to a wider base metal according to the teachings of Spooner, et al. in British Patent No. 1,162,887; hereinafter “the Spooner Patent”. The Spooner patent addresses the inherent problems associated with applying a solder stripe to a substrate. A non-exhaustive list of the problems includes controlling the width, thickness, and location of the molten solder profile. Moreover, the Spooner patent purportedly addresses problems that occur while the substrate is moving at high speeds. The Spooner patent teaches a method of continuously bonding a narrow, preformed strip of solder onto a wider base metal strip, which method generally comprises the steps of:

continuously pulling the base metal substrate and the solder strip towards each other;

wipe-wetting all or a portion of the base metal substrate in a longitudinal direction with flux;

superposing the solder strip onto the base metal substrate at the desired location;

compressing the solder strip onto the base metal substrate;

heating the joined solder strip and base metal substrate; and

cooling the joined solder strip and base metal substrate.

Problems inherent to the Spooner process, however, include the lack of control over the molten solder profile during the heating step, which, as a result, requires further post-cooling machining to reduce the rough solder profile to the desired solder profile. This additional machining requires special equipment, additional equipment operators, and time to perform, which equate to greater expense. Furthermore, solder that is removed during the machining process is wasted, which is another unnecessary expense. Finally, the process described in the Spooner patent can only be used to provide a solder profile on one surface of the metal substrate. Thus, Spooner does not teach or disclose a method for providing solder profiles on both surfaces of the metal substrate.

### BACKGROUND OF THE INVENTION

In this setting, it would be desirable to provide devices for and methods of continuously casting and bonding at least one, e.g., metal, profile onto a wider moving substrate that minimize post-solidification machining requirements and the amount of waste solder. Such a method solidifies a defined cross-section of a molten material, e.g., metal casting onto a moving substrate further utilizing the moving substrate itself as one of the containing sides of the casting die. Such devices and methods, necessarily, require that the molten material be cast onto a heated, moving substrate through at least one casting die, and preferably through two dies that are disposed on the upper and lower surfaces of the heated substrate, and subsequently cooled.

More particularly, it also would be desirable to provide devices for and methods of continuously casting and bonding at least one metal profile of a defined cross-section onto a moving base metal substrate. Such devices and methods, necessarily, require that the molten material, e.g., solder, be cast onto a heated, moving substrate through at least one casting die, and preferably two dies that are disposed on the upper and lower surfaces of the heated, moving substrate, and subsequently cooled to solidify.

### SUMMARY OF THE INVENTION

In general, the present invention includes methods of and devices for continuously casting molten material, e.g., solder, onto one or more surfaces of a moving substrate, e.g., a metal strip, to provide one or more profiles on one or more surfaces are disclosed in the present invention. In general, the casting method includes providing a substrate, a heated reservoir of a molten material, and a casting die; moving the substrate past the casting die into which the molten material is introduced; containing the molten material in a casting channel in the casting die against the one or more surfaces of the moving substrate; heating the casting die to prevent the molten material from solidifying against the casting surface prematurely; and cooling the molten material to solidify the molten material to provide one or more profiles on one or more surfaces of the moving substrate and to bond the solidified profile(s) to the one or more surfaces. In general, the device for casting and bonding a molten material to one or more surfaces of a moving substrate includes a casting die for wetting the moving substrate with the molten material to provide one or more desired profiles on one or more surfaces of the moving substrate; a heating system to prevent molten material from solidifying in the casting die; and a cooling device for solidify the molten material in the desired profile(s) and for bonding the desired profile(s) to the one or more surfaces of the moving substrate.

One embodiment of the present invention provides a method of casting molten material one or more surfaces of a moving substrate to provide one or more profiles on at the one or more surfaces, the method comprising the steps:

providing a moving substrate;

providing a casting device that includes a casting die and a cooling device;

providing a reservoir of molten material and a conduit to communicate the molten material to the casting die;

moving the substrate past the casting die,

containing and shaping the molten material into a profile against one or more surfaces of the moving substrate;

heating the casting channel to prevent molten material from solidifying against the channel surfaces, thereby allowing the molten material to fill the casting channel completely; and

cooling the molten material in a cooling device to solidify the molten material to provide one or more profiles on one or more surfaces of the moving substrate to retain the shape of the casting channel when exiting and to bond the profile(s) to the moving substrate.

Optionally, the method can include pre-heating the moving substrate prior to moving the substrate past the casting die; and applying flux to at least one surface of the moving substrate prior to moving the substrate past said casting die.

Modifications and variations of this first embodiment can include casting the molten material to the upper and lower surfaces of the moving substrate while the apparatus is substantially parallel or substantially orthogonal to the direction of movement of the moving substrate.

In a second embodiment, the present invention includes an apparatus for casting and bonding a molten material onto one or more surfaces of a moving substrate to provide one or more profiles those surfaces, wherein the apparatus comprises:

a casting device;

a decoiling device from which the moving substrate is drawn; and

a coiling device onto which the moving substrate, having one or more profiles is collected, wherein the casting device comprises:

a heated reservoir for containing molten material;

a casting die, having upstream and downstream portions and at least one casting channel that is disposed between the upstream portion and the downstream portion, past which the moving substrate is capable of being moved, wherein the casting channel(s) faces the surface(s) of the moving substrate and contains and shapes the molten material into a profile(s) against those surfaces;

a heating system for heating the upstream portion and casting channel of the casting die to prevent the molten material from solidifying within the casting channel, thereby allowing the molten material to fill the casting channel completely; and

a cooling device for solidifying the molten material to provide one or more profiles against said one or more surfaces of the moving substrate and for bonding the profile(s) to those surfaces.

An apparatus in accordance with the present embodiment also can comprise a pre-heating device to heat the moving substrate prior to the substrate entering the casting device to remove contaminants and to improve bonding; and a fluxing device that applies a flux to the moving substrate to remove contaminants.

Modifications and variations of this second embodiment can include casting the molten material to the upper and lower surfaces of the moving substrate while the casting is substantially parallel or substantially orthogonal to the direction of movement of the moving substrate. Moreover, when the apparatus provides one or more profiles on the upper and lower surface, the apparatus further comprises a plurality of equalization channels that allow molten material to communicate with a first casting device that is disposed to face the upper surface of the moving substrate and a second casting device that is disposed to face the lower surface of the moving substrate.

In a third embodiment, the present invention teaches a casting device for casting molten material to provide a profile(s) on one or more surfaces of a moving substrate. Accordingly, the casting device comprising:

a heated reservoir for containing molten material;

a casting die, having upstream and downstream portions and at least one casting channel that is disposed between the upstream portion and the downstream portion, past which the moving substrate is capable of being moved, wherein said at least one casting channel faces said at least one upper surface and lower surface of said moving substrate and contains and shapes the molten material into one or more profiles against at least one of said upper surface and said lower surface of the moving substrate;

a heating system for heating the upstream portion and casting channel of the casting die to prevent the molten material from solidifying within the casting channel, thereby allowing the molten material to fill the casting channel completely; and

a cooling device for solidifying the molten material to provide a profile(s) on a surface(s) of the moving substrate and for bonding the profile(s) to the surface(s) of the moving substrate.

Preferably, this embodiment of the present invention comprises an upper die portion that is removably attachable to a lower die portion, wherein at least one of the upper die portion and the lower die portion includes a casting channel having casting surfaces for containing and shaping the molten material into a profile against at least one surface of the moving substrate. More preferably, the upper mold is a reverse mirror image of the lower mold.

In a fourth embodiment, the present invention teaches a die for casting molten material to provide one or more profiles on a single surface of a moving substrate. More specifically, the die comprises:

an upper die portion having a casting channel further having casting surfaces for containing and shaping the molten material into one or more profiles against a single surface of the moving substrate;

a lower die portion that is releasably attachable to the upper die portion; and

an inlet for communicating molten material from a heated reservoir to the casting channel of the upper die portion.

Alternatively, the die further can comprise a plurality of heating elements for heating the die to prevent molten material from solidifying within the casting channel to allow the molten material to fill the casting channel completely; a solidification region having cooling means that is disposed downstream of the casting channel for solidifying the molten material to provide one or more profiles and bonding said one or more profiles to the upper surface of the moving substrate; and/or a temperature isolation barrier that is disposed between the casting channel and the solidification region.

In a fifth embodiment, the present invention teaches a die for casting molten material to provide one or more profiles on an upper surface one or more profiles on a lower surface of a moving substrate. More specifically, the die comprises:

an upper die portion having a first casting channel further having casting surfaces for containing and shaping the molten material into one or more profiles against the upper surface of the moving substrate;

a lower die portion having a second casting channel further having casting surfaces for containing and shaping the molten material into one or more profiles against the lower surface of the moving substrate, wherein the lower die portion is releasably attachable to the upper die portion; and

an inlet for communicating molten material from a heated reservoir to the casting channels.

Optionally, the die, further, can include a plurality of equalization channels that are structured and arranged between the first casting channel and the second casting channel to allow molten material to communicate between the first casting channel and the second casting channel.

Alternatively, the die further can comprise a plurality of heating elements for heating the die to prevent molten material from solidifying within the first and second casting channels to allow the molten material to fill the first and second casting channels completely; a solidification region having cooling means that is disposed downstream of the first and second casting channels for solidifying the one or more profiles and bonding said one or more profiles to the upper and lower surfaces of the moving substrate; and/or a temperature isolation barrier that is disposed between the casting channels and the solidification region.

### BRIEF DESCRIPTION OF THE DRAWING

For a fuller understanding of the nature and desired objects of the present invention, reference is made to the following detailed description taken in conjunction with the accompanying drawing figures wherein like reference characters denote corresponding parts throughout the several views and wherein:

FIG. 1 shows an illustrative embodiment of an apparatus for casting and bonding a molten material to one or more surfaces of a substantially horizontally moving substrate;

FIG. 2 shows an illustrative embodiment of an apparatus for casting and bonding a molten material to one or more surfaces of a substantially vertically moving substrate;

FIG. 3A shows a side, cut-away view of an embodiment of a single-sided casting device for casting a molten material to provide a profile on a single surface of a moving substrate;

FIG. 3B shows a cross-sectional view of an embodiment of the strip sealing section of a single-sided casting device;

FIG. 3C shows a cross-sectional view of an embodiment of the reservoir and transition zone of a single-sided casting device;

FIG. 3D shows a cross-sectional view of an embodiment of the solidification region of a single-sided casting device;

FIG. 4A shows a side, cut-away view of an embodiment of preheating means and fluxing means;

FIG. 4B shows a top view of an embodiment of preheating means and fluxing means;

FIG. 5 shows a cross-sectional view of another embodiment of the solidification region of a single-sided casting device;

FIG. 6A shows a side, cut-away view of an embodiment of a double-sided casting device for casting a molten material to provide a profile on an upper surface and a lower surface of a moving substrate;

FIG. 6B shows a cross-sectional view of an embodiment of the strip sealing section of a double-sided casting device;

FIG. 6C shows a cross-sectional view of an embodiment of the reservoir and transition zone of a double-sided casting device;

FIG. 6D shows a cross-sectional view of an embodiment of the solidification region of a double-sided casting device;

### DETAILED DESCRIPTION OF THE INVENTION AND THE PREFERRED EMBODIMENTS THEREOF

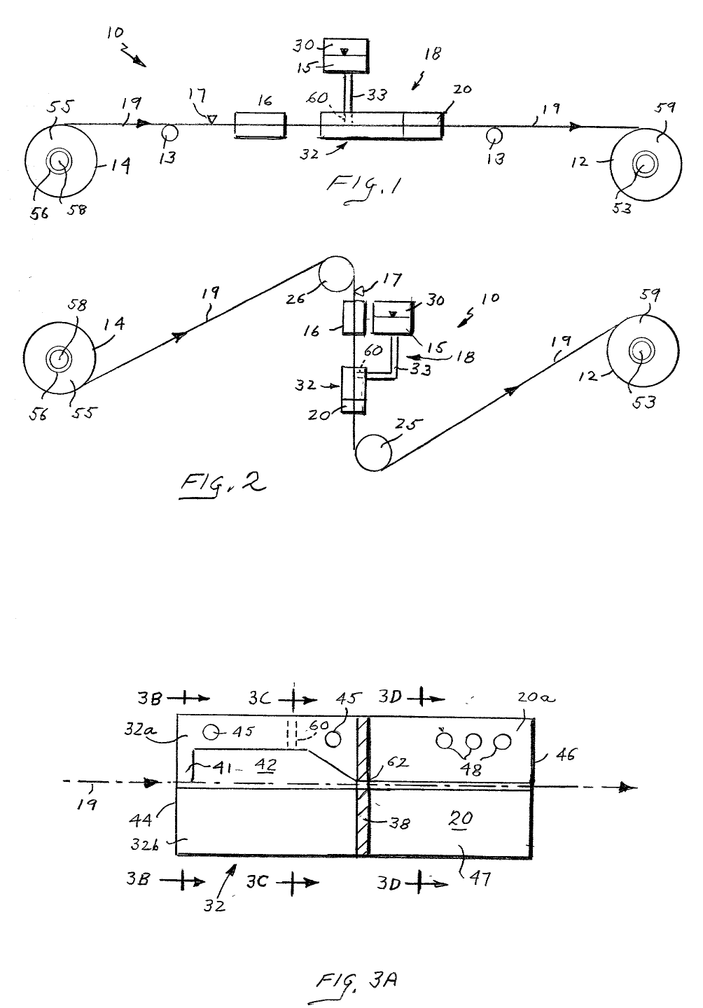

Referring now to the various figures, there is shown in FIG. 1 a first embodiment of an apparatus 10 for casting and bonding a molten material 15 onto a substantially horizontally moving substrate 19 to provide a profile 35, wherein the profile that is less wide than the lateral dimension of the moving substrate 19. Preferably, the molten material 15 comprises a molten metal or metal alloy and the moving substrate 19 comprises a strip of a base metal. More preferably, the molten material 15 is a lead-tin solder that can include trace amounts of, e.g., silver, indium, bismuth, antimony, and/or copper, and the moving substrate can include strips of copper, copper alloys, and/or ferrous metals. Alternatively, the molten material 15 can be lead and or indium.

Those skilled in the art will appreciate that changes and variations can be made to the apparatus 10 without departing from the spirit or scope of this disclosure. Indeed, the invention can be practiced using other than metal molten material 15. For example, the molten material 15 can include glass, rubber, polymers, plastics, carbonaceous products and the like and the moving substrate 19 can include porous materials, e.g., a mesh, screen, fibers, and the like.

In a preferred embodiment, the apparatus 10 comprises a take-up coiler device 12, a pay-off decoiler device 14, a preheating device 16, and a casting device 18. Optionally, one or more idle coilers 13 can be disposed, e.g., between the pay-off decoiler device 14 and the preheating device 16 and/or between the take-up coiler device 12 and the casting device 18, to guide and provide intermediate support to the moving substrate 19. Optionally, the apparatus 10 also can be structured and arranged to include a fluxing device 17.

A preferred method of casting and bonding a molten material 15 onto a moving substrate 19 to provide at least one profile 35 thereon will now be described to better describe the function of and interplay between the elements of the apparatus 10. In a preferred embodiment, the moving substrate 19, hereinafter the “metal strip 19”, is structured and arranged, e.g., in an unwindable, rotatable coil 55 of a type that is well known to the art. The unwindable, rotatable coil 55 can include a central hub 56 of sufficient dimension to pass over a supporting bar or axle 58. If the bar or axle 58 is fixedly attached to the apparatus 10 or to a separate support structure so as not to rotate, then there should be sufficient clearance between the outer diameter of the bar or axle 58 and the inner diameter of the hub 56 to allow the coil 55 to rotate freely about the bar or axle 58 when a pulling force is applied to the free, running end of the metal strip 19. Alternatively, if the bar or axle 58 is rotatable and/or driven by a motor, then the dimensions of the central hub 56 of the coil 55 provide an interference fit with the bar or axle 58.

Preferably, the coil 55 is disposed on the pay-off decoiler device 14. The pay-off decoiler device 14 can comprise, e.g., a cylindrical, substantially horizontal bar or axle 58 that is fixedly attached to the apparatus 10 at one end thereof, i.e., at the decoiling end, or to a separate support structure (not shown) so as not to rotate. Alternatively, the bar or axle 58 is rotatably attached to the apparatus 10, e.g., at the decoiling end, or to a separate support structure. According to this alternative arrangement, the bar or axle 58 can rotate about an axis. Preferably, a drive motor (not shown) that is capable of providing any desirable rate of rotation can rotate the bar or axle 58 to facilitate the decoiling, or unwinding, process.

The metal strip 19 that is wound on the coil 55 can be unwound by applying a pulling force to the free, running end of the coil 55. After the metal strip 19 leaves the coil 55, the metal strip 19 can enter a preheating device 16 where it can be heated to a temperature that is about 20 to about 100 degrees Fahrenheit (° F.) above the liquidus temperature of the molten material 15. The purpose of preheating the metal strip 19 is twofold. First, the heat removes some of the contaminants on the surfaces of the metal strip 19. Secondly, a heated metal strip 19 provides enhanced adherence, i.e., bonding, of molten material 15 than a cooler metal strip 19 provides.

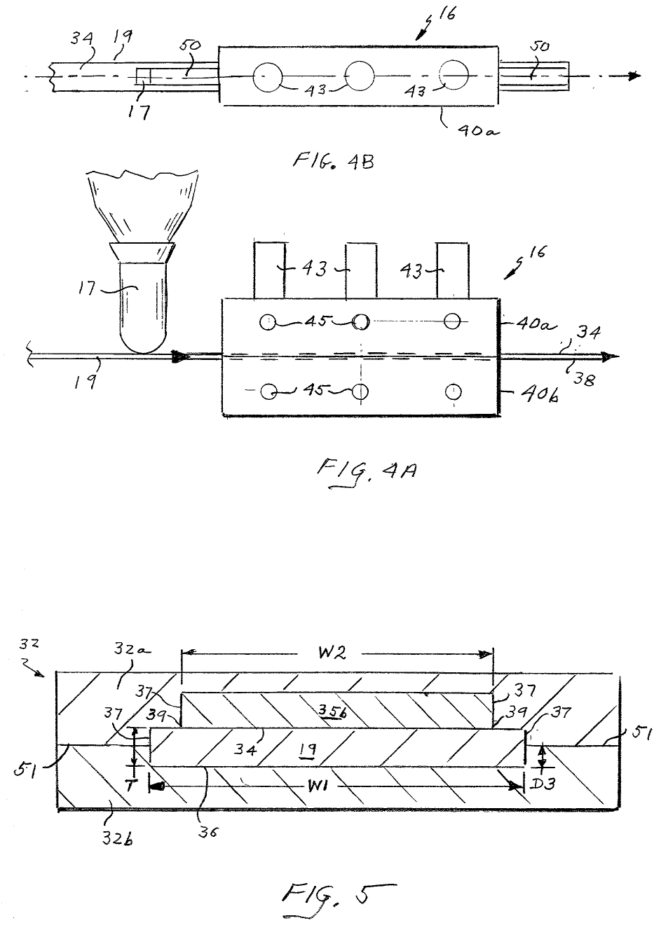

Preheating is provided through one or a combination of the following means, depending on the alloy system and its heating requirements. Heating requirements are determined relative to the liquidus of the cast metal, the heat capacity, thermal conductivity of the metal strip 19 run rates, and oxidation considerations. Referring to FIG. 4A, preferably, when molten material 15 is applied to a metal strip 19 that is structured and arranged in a substantially horizontal orientation, preheating is accomplished by conduction using heated, highly-conductive, e.g., copper or graphite, blocks 40a and 40b that thermally communicate with the metal strip 19 for the purpose of heating the metal strip 19 before the metal strip 19 enters the casting device 18. Heating blocks 40a and 40b can be disposed to communicate heat by conduction to the upper surface 34 of the metal strip 19 and the lower surface 38 of the metal strip 19, respectively. Alternatively, just the upper heating block 40a can be disposed to communicate thermally with so to heat upper surface 34 of the metal strip 19. Exceptional heat transfer into the metal strip 19 is accomplished by conduction due to the intimate contact of the heated block 40a or heated blocks 40a and 40b and the metal strip 19.

Blocks 40a and 40b can be heated by one or more heating elements 45 that thermally communicate with the blocks 40a and 40b. Although, FIG. 4A shows six heating elements 45 contained within the heating blocks 40a and 40b, the number of heating elements 45 and their disposition are shown illustratively and the invention is not to be construed as being so limited. More or fewer heating elements 45 can be used to transfer heat to the heating blocks 40a and 40b. Furthermore, the heating elements 45 do not have to be contained within the physical structure of the heating blocks 40a and 40b. For example, the heating elements 45 can thermally communicate with one or more outer surfaces of the blocks 40a and 40b.

Preferably, the heating elements 45 can be heated by gas flame and/or electrically. Alternatively, means for heating the heating elements 45, e.g., steam, solar power, and the like, can be used without violating the scope and spirit of this invention.

A plurality of springs 43 is shown in FIGS. 4A and 4B. The springs 43 are used to maintain intimate contact between the heating blocks 40a and 40b and the metal strip 19 to maximize conductive heat transfer therebetween. Although, FIGS. 4A and 4B show three springs 43, which are shown only for illustrative purposes, those of ordinary skill in the art can appreciate that the invention can be practiced using more or fewer springs 43. Furthermore, FIGS. 4A and 4B show a plurality of springs 43 that is disposed against the upper heating block 40a. Those of ordinary skill in the art can appreciate that the invention can be practiced using a plurality of springs 43 that is disposed against the lower heating block 40b or both heating blocks 40a and 40b.

In an alternative preheating embodiment, the molten reservoir or bath 30 can be extended lengthwise upstream beyond the metal strip 19 length that is required for volumetric flow. See FIG. 2. Accordingly, exceptional heat transfer into the metal strip 19 is accomplished by conduction due to the intimate or proximal contact of the molten bath 30 and the metal strip 19. An advantage of this embodiment over the embodiment previously described is that it uses the molten reservoir 30 to heat the metal strip 19, which eliminates the need for a separate heating means 16.

Optionally, the apparatus 10 can include a fluxing device 17. The fluxing device 17 can be disposed generally before the preheating means 16 so as to wet the at least one of the upper and lower surfaces 34 and 38 of the metal strip 19 with a flux 50. Typically, commercially known, acid-based fluxes 50 are applied to one or more surfaces of the metal strip 19 to remove oxidants and other contaminants, which can further enhance the adherence of molten material 15 to the metal strip 19.

After the metal strip 19 has been preheated and, if desired, fluxed, the metal strip 19 enters a casting device 18 where a molten material 15 is cast onto, i.e., “wets”, one or more surfaces of the metal strip 19 in a casting device 32 and subsequently is cooled by a cooling means 20 to provide at least one desired profile 35b.

The embodied casting device 18 includes a heated reservoir 30, a casting die 32, a conduit 33, which communicates between the heated reservoir 30, and the casting die 32, and a cooling device 20. The heated reservoir 30 is structured and arranged to contain the molten material 15 and to maintain it in a molten state. Typically, the temperature of the heated reservoir 30 is maintained at about 50 to about 100° F. above the liquidus of the material 15 that is to be cast onto the metal strip 19. A plurality of heating elements (not shown), e.g., integrated, electrical resistance heaters, heat the reservoir 30 to maintain the material 15 in a molten state, i.e., to a temperature above the liquidus of the metal alloy. Those skilled in the art will appreciate that other means of heating the casting means 18 are possible and that the present invention is not to be construed as being limited to electrical resistance heaters.

The conduit 33 through which the molten material 15 can be delivered to the casting die 32 can be heated to a temperature between about 20 to about 100° F. above the liquidus of the alloy material to prevent molten material 15 from congealing in the conduit 33 before the molten material 15 reaches the casting channel 42 in the casting die 32. Those skilled in the art will recognize that the heating temperature of the casting device 18 and the elements thereof is dependent on the composition, i.e., liquidus, solidus, and phase characteristic of the specific alloy being cast on the metal strip 19. Conduits 33 are heated using, e.g., electrical resistance means for assured temperature control. Preferably, molten material 15 travels from the heated reservoir 30, through the conduit 33, to the casting die 32 by gravity flow. However, a pump (not shown) can be added to pump the molten material 15 under pressure into the casting die 32.

The casting die 32 also can be heated to a temperature between about 20 to 100° F. above the liquidus of the alloy material to prevent molten material 15 from congealing against inner surfaces of the casting die 32 before the desired profile 35b is provided. The heating elements for the heated reservoir 30 also are capable of heating the casting die 32.

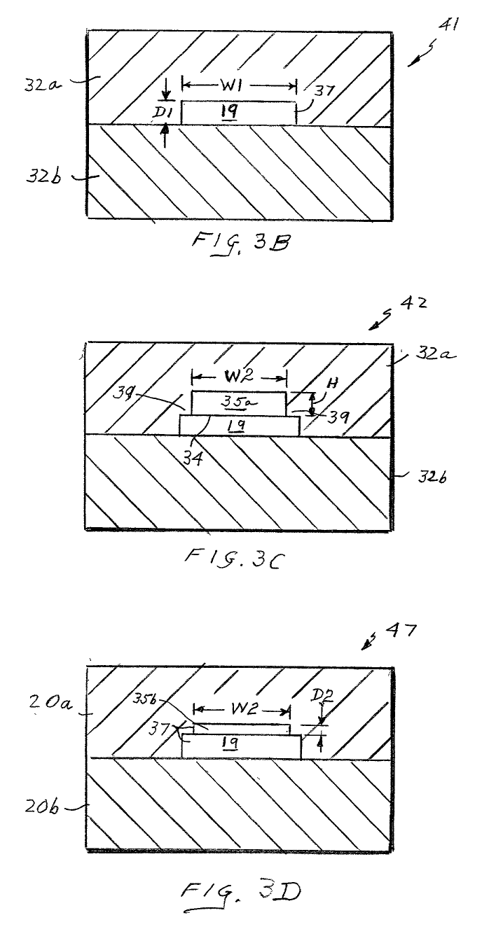

Referring to FIGS. 3A to 3D, a preferred embodiment of a casting device 18 for providing a single profile 35b on the upper surface 34 of a metal strip 19, i.e., a single-sided casting device 18, now will be described. In the illustrative embodiment, the casting die 32 and the cooling device 20 are shown as a single structure with a thermal isolation barrier 38 disposed therebetween. FIG. 3B provides a cross-sectional view of the heated strip sealing section 41 of a single-sided casting die 32. FIG. 3C provides a cross-sectional view of the reservoir and transition zone 42 of a single-sided casting die 32. FIG. 3D provides a cross-sectional view of the solidification zone 47 of the cooling device 20.

The casting die 32 comprises an upper die portion 32a and a lower die portion 32b, which can be removably attached to each other, e.g., using clamps, bolts, screws, vises, and the like. The upper and lower die portions 32a and 32b are structured and arranged so that the metal strip 19 first encounters a heated strip sealing section 41 that is disposed at a proximal, or upstream, end 44 of the casting die 32. After the heated strip sealing section 41, the metal strip 19 passes successively through a heated reservoir and transition zone, or casting channel, 42, a thermal isolation zone 38, and a solidification region 47 in the cooling device 20 before exiting the casting device 18 at a distal, or downstream, end 46.

The strip sealing section 41 is disposed upstream of the casting channel 42 and substantially confines and guides the metal strip 19 before molten material 15 is cast onto, or “wets”, the metal strip 19 in the reservoir and transition zone 42. As shown in FIG. 3B, the strip sealing section 41 comprises a cavity 37 that is disposed, e.g., in the upper die portion 32a. Preferably, the cavity 37 extends along the entire length of the casting device 18 and the dimensions, i.e., width W1 and depth D1, of the cavity 37 in the strip sealing section 41 are only slightly larger than the corresponding dimensions of the metal strip 19 so that the metal strip 19 is confined and guided within the strip sealing zone 41 without undue frictional contact between the moving strip 19 and the walls of the cavity 37. The strip sealing section 41 and the metal strip 19 are heated by a plurality of heating elements 45 that are in thermal communication with the casting die 32.

After passing through the strip sealing section 41, the metal strip 19 enters a reservoir and transition zone 42, i.e., a casting channel, in which molten material 15 is cast onto, i.e., “wets”, the metal strip 19 to provide, successively, a rough profile 35a and then a dimensionally consistent final profile 35b. The reservoir portion of the reservoir and transition zone 42 is in communication with the conduit 33 leading to the heated reservoir 30 via one or more inlets 60, which allows molten material 15 to gravity flow or be pumped from the heated reservoir 30 to the reservoir portion of the reservoir and transition zone 42. One or more inlets 60 communicate further between the reservoir portion of the reservoir and transition zone 42 and the conduit 33 to provide a means for continuously communicating molten material 15 into the reservoir portion of the reservoir and transition zone 42 to provide a rough profile 35a. Preferably, a single, circular inlet 60 having a diameter of about ½inch can ensure the necessary flow of molten material 15 to fill the reservoir and transition zone 42.

The casting and bonding system 10 of the present invention can be run in a state of balance between molten material 15 being fed into the reservoir portion of the reservoir and transition zone 42 and the amount of molten material 15 that exits the transition portion of the reservoir and transition zone 42 in a preferred profile 35b. The excess molten material 15 held in the reservoir portion of the reservoir and transition zone 42 is available for maintaining sufficient molten material 15 during any inconsistencies in flow rate.

Referring to FIG. 3C, the dimensions of the reservoir portion of the reservoir and transition zone 42 are structured and arranged to provide a rough profile 35a of molten material 15 at any desired location or locations on the upper surface 34 of the metal strip 19. The volume of the reservoir portion of the reservoir and transition zone 42 can be increased beyond minimal volume requirements to heat the metal strip 19 further.

The rough profile 35a of molten material 15 provided in the reservoir portion of the reservoir and transition zone 42 can be characterized as providing the desired profile width W2, which, dimensionally is less wide than the width W1 of the metal strip 19, and a height H, which exceeds a desired depth D2 of the final profile 35b, i.e., the height H of the rough profile 35a in the reservoir portion of the reservoir and transition zone 42 is greater than the final depth D2. To confine the molten material 15, provide a rough profile 35a, and prevent the molten material 15 from flowing laterally across the upper surface 34 of the metal strip 19, the shoulders 39 that define the profile width W2 are in intimate, frictional communication with the metal strip 19 to provide a seal against the upper surface 34 of the metal strip 19. The reservoir and transition zone 42 and the metal strip 19 are heated by a plurality of heating elements 45 that are in thermal communication with the casting die 32.

After the metal strip 19 is wet in the reservoir portion of the reservoir and transition zone 42, the metal strip 19 then moves to the transition, or tapered, portion of the reservoir and transition zone 42. The tapered portion of the reservoir and transition zone 42 tapers, e.g., uniformly, in the direction of movement of the metal strip 19 from the maximum height H of the reservoir portion to the desired depth D2 of the final profile 35b. Accordingly, the rough profile 35a progressively shrinks vertically to provide a final profile 35b of the molten material 15 on the metal strip 19. As the dimensions of rough profile 35a transition to the dimensions of the final profile 35b, excess molten material 15 remains in the reservoir and transition zone 42, which can reduce wastage and better assure that the molten material 15 completely fills the profile 35b, especially during periods of inconsistent delivery of molten material 15.

The wetted metal strip 19 with a liquidus final profile 35b then passes downstream of the casting channel 42 through a thermal isolation barrier 38 and then into the solidification region 47 in the cooling device 20. The thermal isolation barrier, or slot, 38 minimizes heat transfer between the reservoir and transition zone 42 and the solidification region 47. Moreover, the thermal isolation barrier 38 isolates the temperature gradient of the casting die 32.

Preferably, the isolation barrier, or slot, 38 comprises an air gap that surrounds an enclosed die channel 62 that connects the casting die 32 to the cooling device 20. Alternatively, the thermal isolation barrier 38 can include material with high insulating characteristics, e.g., ceramic. Preferably, the enclosed die channel 62, which connects the transition portion of the reservoir and transition zone 42 to the cooling device 20 has substantially the same cross section and dimensions as the final profile 35b as it exits the transition portion of the reservoir and transition zone 42.

The cooling device 20 includes a cavity 37, e.g., in an upper block 20a, substantially corresponding to the dimension of the metal strip 19 and the final, desired profile 35b, that comprises a solidification zone 47 and one or more cooling channels 48. The purpose of the cooling device 20 is to allow the molten material 15 and metal strip 19 to cool sufficiently to solidify the molten material 15 to provide a final profile 35b and to bond the profile 35b to the metal strip 19.

Preferably, a coolant, e.g., cold water, oil, chilled gas, and the like circulates through a plurality of, e.g., transverse, cooling channels 48 that are disposed in the cooling device 20 to provide a temperature in the cooling device 20 of about 20 to about 150° F. below the liquidus of the molten material 15. Preferably, the coolant is metered through the plurality of cooling channels 48 using the flow rate of the coolant, which can be metered, e.g., using pressure valves, and the ambient temperature of the coolant to balance heat removal.

After passing through the cooling device 20, the metal strip 19 exits the casting device 18 through the distal end 46 and is recovered on a take-up coil 59. The final profile 35b is fully solid upon leaving the cooling device 20. Further, the final profile 35b is bound to the metal strip 19. Optionally, the final profile 35b can be rolled or skived to correct the shape or improve the surface quality of the profile 35b.

The take-up coil 59 is structured and arranged, e.g., in a windable, rotatable coil 59 of a type that is well known to the art. The coil 59 can be disposed on the take-up coiler device 12. The take-up coiler means device 12 can comprise, e.g., a cylindrical, substantially horizontal bar or axle 53 that is rotatably attached to the apparatus 10 at, e.g., the coiling end, or to a separate support structure (not shown). The bar or axle 53 can rotate about an axis. Preferably, a drive motor (not shown) that is capable of providing any desirable rate of rotation can rotate the bar or axle 53 to facilitate the coiling, or winding, process and to provide a force to the free running end of the unwinding coil 55 to move the metal strip 19 through the various means described above.

Referring to FIG. 5, there is shown an illustrative example of an alternative embodiment of the single-sided casting device 18 just described. The upper die portion 32a and lower die portion 32b of this embodiment can be structured and arranged with corresponding cavities 37 and grooves 36 in the upper and lower die portions 32a and 32b, respectively, rather than just having a cavity 37 in the upper die portion 32a. Although FIG. 5 only shows a cross-section of the casting device 18 in the solidification region 47 of the cooling device 20, those skilled in the art can appreciate and modify the above teaching in each of the other regions previously described.

The lower die portion 32b includes a guiding groove 36 for guiding and substantially, laterally confining the metal strip 19. Preferably, the depth D3 of the guiding groove 36 in the lower die portion 32b is slightly less than the thickness T of the metal strip 19 so that the upper surface 34 of the metal strip 19 extends slightly above the top surface 51 of the lower mold 32b and just slightly wider that the width W1 of the metal strip 19 so that the metal strip 19 is not in continuous frictional engagement with the side walls of the guiding groove 36.

The upper die portion 32a includes a corresponding cavity 37 for further guiding and substantially confining the metal strip 19 that also provides a desired profile 35b. One or more inlet openings 60 communicate between the reservoir portion of the reservoir and transition zone 42 and the conduit 33 to provide a means for continuously communicating molten material 15 into the reservoir portion of the reservoir and transition zone 42 to provide a rough profile 35a. Preferably, the upper die portion 32a is maintained at a temperature that prevents congealing of the molten material 15 before the molten material 19 has filled up the entire profile 35.

To confine the molten material 15 from flowing laterally across the upper surface 34 of the metal strip 19, the shoulders 39 that define the profile width W2 of the final profile 35b are in intimate, frictional communication with the metal strip 19 so as to provide a seal against the upper surface 34 of the metal strip 19.

In yet another embodiment (not shown), the guiding groove 36 in the lower die portion 32b can be structured and arranged to have substantially the same width W1 and depth D3 as the width W and thickness T of the metal strip 19, respectively. The casting channel 42 in the upper die portion 32a, then, would be structured and arranged to provide a rough profile 35a and a final profile 35b. Once again, to confine the molten material 15 from flowing laterally across the upper surface 34 of the metal strip 19, the shoulders 39 that define the profile width W2 of the final profile 35b are in intimate, frictional communication with the metal strip 19 so as to provide a seal against the upper surface 34 of the metal strip 19.

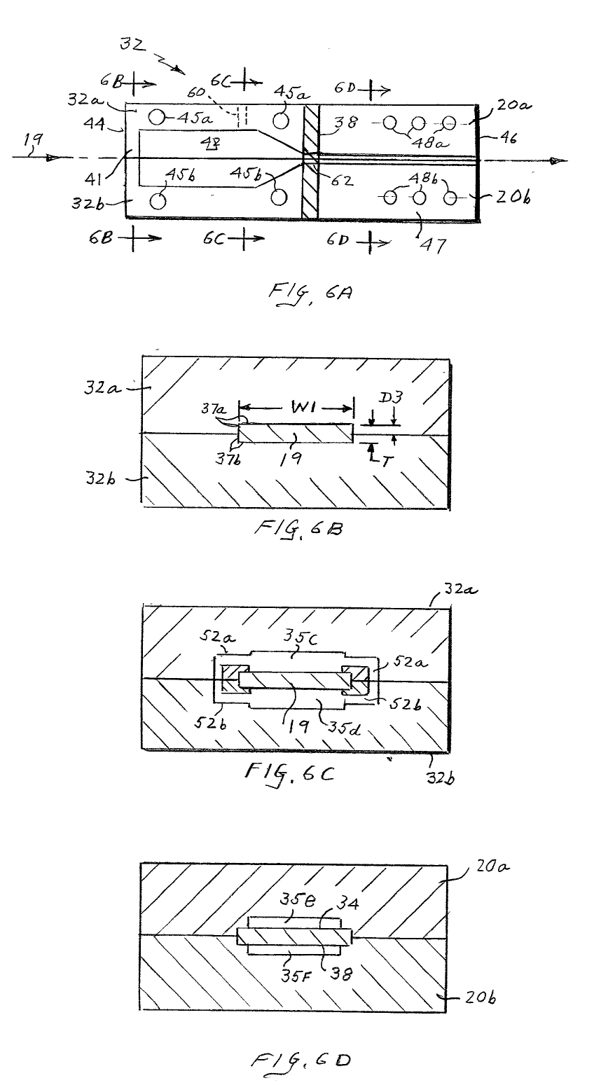

Referring to FIG. 6A, an embodiment of a casting device 18 for providing final profiles 35e and 35f, respectively, on the upper surface 34 and lower surface 38 of a metal strip 19, i.e., a two-sided casting device 18, now will be described

The strip sealing section 41, reservoir and transition zone 42 and solidification zone 47 of the present embodiment are substantially the same as those described above for the single-sided casting device 18 with the following modifications and alterations. Referring to FIG. 6B, the strip sealing section 41 includes upper and lower die portions 32a and 32b having an upper cavity 37a and a lower cavity 37b, respectively. Preferably, the cavities 37a and 37b are reverse mirror images that extend the entire length of the casting die 32. More preferably, the depths D3 of the cavities 37a and 37b are substantially the same and, moreover, approximately equal to one-half the thickness T of the metal strip 19.

Referring to FIG. 6C, in the reservoir and transition zone 42, the upper mold 32a and the lower die portion 32b also can be reverse mirror images of each other. The upper die portion 32a can include a first pair of equalization channels 52a that are structured and arranged to match up with a corresponding second pair of equalization channels 52b that are structured and arranged in the lower die portion 32b. The plurality of equalization channels 52a and 52b provide communication between the upper cavity 37a and the lower cavity 37b so that molten material 15 can flow therethrough to provide a rough upper profile 35c on the upper surface 34 of the metal strip 19 and a rough lower profile 35d on the lower surface 38 of the metal strip 19.

Preferably, the equalization channels 52a and 52b are continuous longitudinally along the length of the reservoir and transition zone 42 of the casting die 32. Alternatively, the equalization channels 52a and 52b can comprise a plurality of discrete channels that are disposed at some, e.g., uniform, interval or intervals along the length of the reservoir and transition zone 42 of the casting device 32. More preferably, in the transition, or tapered, portion of the reservoir and transition zone 42, the equalization channels 52a and 52b also are tapered, e.g., uniformly, in the direction of movement of the metal strip 19. As provided before, both the upper and lower die portions 32a and 32b are heated to ensure that the molten material 15 does not congeal in the cavities 37a and 37b or the equalization channels 52a and 52b before the molten material 15 wets the metal strip 19 and fills out the final profiles 35e and 35f.

Once sufficient molten material 15 wets the metal strip 19 in the reservoir and transition zone 42 and provides final profiles 35f onto the upper and lower surface 34 and 38 of the metal strip 19, the metal strip 19 then passes through the thermal isolation barrier 38 and enters the solidification region 47 of the cooling device 20, which expedites the solidification of the molten material 15 and bonds the molten material to the metal strip 19 to provide profiles 35e and 35f thereon. Preferably, a coolant, e.g., cold water, oil, chilled gas, and the like, circulates through a plurality of, e.g., transverse, cooling channels 48a and 48b that are disposed in at least one of the upper and lower cooling blocks 20a and 20b in the cooling device 20 to provide a temperature of the cooling means 20 of about 20 to about 150 ° F. below the liquidus of the molten material 15. Preferably, the coolant is metered through the plurality of cooling channels 48a and 48b using flow rate of the coolant, which can be metered, e.g., using pressure valves, and the ambient temperature of the coolant to balance heat removal.

FIG. 2 provides yet another embodiment of the apparatus 10 wherein preheating, casting, and cooling take place with the metal strip 19 in a substantially vertical orientation. For reasons that will become obvious to one of ordinary skill in the art, a vertical orientation is ideal for two-side casting as it eliminates the need for equalization channels 52a and 52b.

All of the elements of the substantially vertical embodiment are the same or substantially the same as like numbered elements of the previously described, substantially horizontal orientation, i.e., FIG. 1, and the two-side casting device 18, i.e., FIG. 6A. By orienting the metal strip 19 vertically, equalization of flow between the upper and lower cavities 37a and 37b becomes less problematic as does thermal balancing of the upper and lower die portions 32a and 32b. Furthermore, equalization channels 52a and 52b are not required in the upper and lower die portions 32a and 32b.

Molten material 15 can be introduced at or near a proximal, e.g., top, end 44 of the casting device 32 and/or a conduit 33 that is in communication therewith by disposing a single reservoir 30 above the point at which the edges of the metal strip 19 are initially engaged by the cavities 37 and 36 of the strip sealing section 41. Hence, molten material 15 is free to flow completely around both the upper and lower surfaces 34 and 38 of the metal strip 19. The reservoir portion of the reservoir and transition zone 42 typically is filled with molten material 15 by positioning the outlet conduit 33 directly over the open top of the reservoir portion of the reservoir and transition zone 42. Alternatively, if oxidation of the molten bath 30 becomes a problem, the conduit 33 can be structured and arranged so that molten material 15 enters the reservoir portion of the reservoir and transition zone 42 through a side inlet 60.

The vertically-oriented casting apparatus 10 of FIG. 2 further includes a plurality of, e.g., two, deflector rolls 25 that are used to re-direct the metal strip 19 from a substantially horizontal orientation to a substantially vertical orientation and then back to a substantially horizontal orientation. The plurality or rolls 25 can be idle coilers or can be driven rolls that provide a pulling force to further pull the metal strip 19.

Although preferred embodiments of the invention have been described using specific terms, such descriptions are for illustrative purposes only, and it is to be understood that changes and variations may be made without departing from the spirit or scope of the following claims.

What is claimed is:

1. A method of casting molten material onto at least one of an upper surface and a lower surface of a moving substrate to provide one or more profiles on at least one of said upper surface and said lower surface, the method comprising the steps:
providing said moving substrate;
providing a casting device that includes a casting die and a cooling device;
providing a reservoir of molten material that can communicate said molten material to said casting die;
moving said substrate past said casting die, wherein said casting dies includes upstream and downstream portions and at least one casting channel that is disposed between said upstream portion and said downstream portion facing at least one surface of said moving substrate;
containing and shaping said molten material into a profile against at least one of said upper surface and said lower surface of said moving substrate within said casting channel;
heating said upstream portion and casting channel of said casting die to prevent molten material from solidifying within said casting channel, thereby allowing said molten material to fill said casting channel of said casting die completely; and
cooling said molten material in said cooling device after passing said substrate through said casting channel at said downstream portion to solidify said molten material to provide one or more profiles on at least one of said upper surface and said lower surface to retain said shape of said casting channel when exiting said casting device and to bond said one or more profiles to said moving substrate.

2. The method as recited in claim 1, wherein the method further comprises the steps of:
pre-heating the moving substrate prior to moving the substrate past the casting die; and
applying flux to at least one surface of said moving substrate prior to moving said substrate past said casting die.

3. The method as recited in claim 2, wherein the step of pre-heating the moving substrate includes using the reservoir of molten material to heat said moving substrate by conduction.

4. The method as recited in claim 1, wherein the step of moving the substrate past the casting die further comprises the sub-steps of:
disposing a first die portion of the casting die to face the upper surface of the moving substrate; and
disposing a second die portion of said casting die to face the lower surface of the moving substrate.

5. The method as recited in claim 1, wherein the molten material is cast in a direction that is substantially parallel to the upper and lower surfaces of the moving substrate.

6. The method as recited in claim 1, wherein the molten material is cast in a direction that is substantially orthogonal to the upper and lower surfaces of the moving substrate.

7. The method as recited in claim 1, wherein the step of containing and shaping the molten material into a profile includes the sub-step of:
tapering the casting channel of the casting die to taper the molten material to provide one or more final profiles on at least one of the upper surface and lower surface of the moving substrate after said moving substrate has passed through said casting channel.

8. The method as recited in claim 1, wherein the step of cooling the molten material comprises the sub-step of metering a coolant through a plurality of cooling channels in the cooling device.

9. An apparatus for casting and bonding a molten material onto at least one of an upper surface and a lower surface of a moving substrate to provide one or more profiles on at least one of said upper surface and said lower surface, the apparatus comprising:
a casting device;
a decoiling device from which the moving substrate is drawn; and
a coiling device onto which said moving substrate, having one or more profiles that are bonded to at least one of said upper surface and said lower surface of said moving substrate, is collected,
wherein the casting device comprises:
a heated reservoir for containing molten material;
a casting die, having upstream and downstream portions and at least one casting channel that is disposed between the upstream portion and the downstream portion, past which the moving substrate is capable of being moved, wherein said at least one casting channel faces said at least one upper surface and lower surface of said moving substrate and contains and shapes the molten material into one or more profiles against at least one of the upper surface and the lower surface of the moving;
heating means for heating the upstream portion and casting channel of the casting die to prevent the molten material from solidifying within the casting channel, thereby allowing the molten material to fill the casting channel completely; and
a cooling device for solidifying the molten material to provide one or more profiles against said at least one of said upper surface and said lower surface and for bonding said one or more profiles to said at least one of said upper surface and said lower surface of said moving substrate.

10. The apparatus as recited in claim 9, wherein the molten material is selected from a group comprising metal, alloys, glass, polymers, plastic, rubber, and carbonaceous products.

11. The apparatus as recited in claim 10, wherein the metal is selected from a group comprising lead, indium, and lead-tin solders.

12. The apparatus as recited in claim 9, wherein the moving substrate is selected from a group comprising a strip of base metal and a strip of a porous material.

13. The apparatus as recited in claim 12, wherein the strip of base metal is selected from a group comprising copper, copper alloys, and ferrous alloys.

14. The apparatus as recited in claim 12, wherein the porous material is selected from a group comprising a screen, a mesh, and fibers.

15. The apparatus as recited in claim 9, wherein the molten material is cast in a direction that is substantially orthogonal to at least one of the upper surface and the lower surface of the moving substrate.

16. The apparatus as recited in claim 9, wherein the molten material is cast in a direction that is substantially parallel to at least one of the upper surface and the lower surface of the moving substrate.

17. The apparatus as recited in claim 9, wherein the apparatus further comprises a pre-heating device to heat the moving substrate prior to said moving substrate entering the casting device to remove contaminants from at least one of the upper surface and the lower surface of said moving substrate and to improve bonding.

18. The apparatus as recited in claim 17, wherein the heated reservoir of molten material is used as the pre-heating device to heat the moving substrate.

19. The apparatus as recited in claim 9, wherein the apparatus further comprises a fluxing device that applies a flux to at least one of the upper surface and lower surface of the moving substrate to remove contaminants from said at least one upper and lower surface of the moving substrate.

20. A casting device for casting molten material to provide one or more profiles on at least one of an upper surface and a lower surface of a moving substrate, the casting device comprising:
a heated reservoir for containing molten material;
a casting die, having upstream and downstream portions and at least one casting channel that is disposed between the upstream portion and the downstream portion, past which the moving substrate is capable of being moved, wherein said at least one casting channel faces said at least one upper surface and lower surface of said moving substrate and contains and shapes the molten material into one or more profiles against at least one of said upper surface and said lower surface of the moving substrate;
heating means for heating the upstream portion and casting channel of the casting die to prevent the molten material from solidifying within the casting channel, thereby allowing the molten material to fill the casting channel completely; and
a cooling device for solidifying the molten material to provide one or more profiles against said at least one of said upper surface and said lower surface and for bonding said one or more profiles to said at least one of said upper surface and said lower surface of said moving substrate.

21. The casting device as recited in claim 20, wherein the casting die further comprises:
an upper die portion that is disposed to face the upper surface of the moving substrate; and
a lower die portion that is disposed to face the lower surface of said moving substrate,
wherein said upper die portion is releasably attachable to said lower die portion and wherein at least one of the upper die portion and the lower die portion includes a casting channel having casting surfaces for containing and shaping the molten material into one or more profiles against at least one surface of the moving substrate.

22. The casting device as recited in claim 21, wherein the casting channel in the upper die portion is a reverse mirror image of the casting channel in the lower die portion.

23. The casting device as recited in claim 20, wherein the downstream portion of the casting channel is tapered in a direction of movement of the moving substrate to provide one or more final profiles on at least one of the upper surface and the lower surface of the moving substrate.

24. The casting device as recited in claim 20, wherein the casting die further comprises a plurality of equalization channels that allow molten material to communicate between a first casting channel that is disposed in a first die portion to face the upper surface of the moving substrate to provide one or more profiles thereon and a second casting channel that is disposed in a second die portion to face the lower surface of the moving substrate to provide one or more profiles thereon.

25. The casting device as recited in claim 24, wherein the plurality of equalization channels in the first casting channel and the second casting channel are tapered in a direction of movement of the moving substrate.

26. The casting device as recited in claim 20, wherein the casting device further comprises:
a conduit though which molten material in the heated reservoir communicates with the casting channel of the casting die.

27. The casting device as recited in claim 20, wherein the casting device further comprises a temperature isolation barrier that is disposed between the casting channel of the casting die and the cooling device.

28. The casting device as recited in claim 27, wherein the temperature isolation barrier comprises at least one of an air gap and a ceramic barrier.

29. A die for casting molten material to provide one or more profiles on a single surface of a moving substrate, the die comprising:
an upper die portion comprising a casting channel having casting surfaces for containing and shaping the molten material into one or more profiles against the single surface of the moving substrate;
a lower die portion that is releasably attachable to the upper die portion; and
an inlet for communicating molten material from a heated reservoir to the casting channel of the upper die portion.

30. The die as recited in claim 29, wherein the die further comprises a plurality of heating elements for heating the die to prevent molten material from solidifying within the casting channel to allow the molten material to fill the casting channel completely.

31. The die as recited in claim 29, wherein the casting channel is tapered in a direction of movement of the moving substrate to provide one or more final profiles on the single surface of the moving substrate.

32. A die for casting molten material to provide one or more profiles on an upper surface of a moving substrate and one or more profiles on a lower surface of said moving substrate, the die comprising:
an upper die portion comprising a first casting channel having casting surfaces for containing and shaping the molten material into one or more first profiles against the upper surface of the moving substrate;
a lower die portion comprising a second casting channel having casting surfaces for containing and shaping the molten material into one or more second profiles against the lower surface of the moving substrate, wherein the lower die portion is releasably attachable to the upper die portion; and
an inlet for communicating molten material from a heated reservoir to at least one of the first and the second casting channels.

33. The dies as recited in claim 32, wherein the die further comprises a plurality of equalization channels that are structured and arranged between the first casting channel and the second casting channel to allow molten material to communicate between the first casting channel and the second casting channel.

34. The die as recited in claim 32, wherein at least one of the upper die portion and the lower die portion further include a plurality of heating elements for heating the first and second casting channels to prevent molten material from solidifying within said first and second casting channels to allow the molten material to fill said first and second casting channels completely.

35. The die as recited in claim 32, wherein the first casting channel is a reverse mirror image of the second casting channel.

36. The die as recited in claim 32, wherein at least one of the first casting channel and the second casting channel is tapered in a direction of movement of the moving substrate to provide one or more final profiles, respectively, on the upper surface and lower surface of the moving substrate.
